(19) United States
(12) Patent Application Publication
(10) Pub. No.: US 2016/0275617 A1
(43) Pub. Date: Sep. 22, 2016

(54) C2i (Consume to invest) Stock Ownership Program

(71) Applicant: Claudio Brocado, Weston, MA (US)

(72) Inventor: Claudio Brocado, Weston, MA (US)

(21) Appl. No.: 14/664,879

(22) Filed: Mar. 22, 2015

(51) Int. Cl. G06Q 40/06

(52) U.S. Cl. CPC G06Q 40/06

(57) ABSTRACT

The c2i (consume to invest) concept consists of allowing consumers to acquire stock in participating companies simply by purchasing goods and services from those companies. Instead of offering a certain percentage discount from their list prices, participating companies would offer customers a particular percentage of the list price to be credited back to the consumer's account in the form of shares in the participating company. Such a customer shareholder model should be extended to the existing loyalty and rewards programs many companies have already in place.

As our economy evolves and the labor marketplace consists increasingly of freelance workers, the corporate shareholder ownership program could be extended to freelancers. Instead of receiving all of their compensation from multiple ‘employers’ in cash, freelancers could choose to be paid by some corporations for which they perform work with stock in the relevant company.

The c2i (consume to invest) concept consists of allowing consumers to acquire stock in participating companies simply by purchasing goods and services from those companies. Instead of offering a certain percentage discount from their list prices, participating companies would offer customers a particular percentage of the list price to be credited back to the consumer's account in the form of shares in the participating company. Such a customer shareholder model should be extended to the existing loyalty and rewards programs many companies have already in place.

How could it work?

Companies would announce from time to time promotions whereby they would offer key discounts on selected products or services. The discounts would not be a certain percentage reduction in the price, but the percentage of the regular price that would be convertible into company stock at the market price. For example, GM could announce the following promotion. Through December 31, the Chevy Camaro will be eligible for a 2% discount, payable to buyers in GM shares at the closing market price of the stock on the closest possible day following the purchase.

Throughout my career, I was able to develop extensive contacts at a large number of corporations. These contacts will enable me to present the idea of developing the c2i stock ownership program by having companies adopt it as one of their key promotional activities in their offering of products and services.

### CLAIM

To my knowledge, I am the first person to suggest that corporations consider using “stock incentives” for consumers of a company's products of services. As soon as this patent is granted, I plan to contact key corporate executives I know in order to set up a pilot program to start implementing the c2i stock ownership program.

### Logical Extensions to the c2i Model

As already mentioned, the c2i customer shareholder model should be expanded to existing corporate loyalty and reward programs. Moreover, the possibility of owning shares in a corporate client, the program could be extended also to a corporation's suppliers.

As our economy continues to evolve and the labor marketplace consists increasingly of freelance workers, the corporate shareholder ownership program could easily be extended to include freelance workers. Instead of receiving all of their compensation from multiple ‘employers’ in the form of cash, freelancers could choose to be paid by some corporations for which they perform work with stock in the relevant company.

### CONCLUSION

A closer alignment in the interests of various stakeholders at the corporate level in our free-market capitalist system (which in recent decades has been increasingly embraced around the world) would continue to improve its long-term prospects. To the extent that growing numbers of would-be small investors participate in the long-term rewards of stock ownership, they will be increasingly vested in the success of an ever larger number of corporations. The c2i concept is a simple first step to address the potential polarization that may result from the growing gap between those who own capital and those who do not. To my knowledge, no one else has previously developed a scheme whereby a consumer's use of a company's products or services would be rewarded with stock in the corporation offering the products or services.

1. To my knowledge, I am the first person to suggest that corporations consider using “stock incentives” for consumers of a company's products of services. As soon as this patent is granted, I plan to contact key corporate executives I know in order to set up a pilot program to start implementing the c2i stock ownership program. The c2i (consume to invest) concept consists of allowing consumers to acquire stock in participating companies simply by purchasing goods and services from those companies. Instead of offering a certain percentage discount from their list prices, participating companies would offer customers a particular percentage of the list price to be credited back to the consumer's account in the form of shares in the participating company. Such a customer shareholder model should be extended to the existing loyalty and rewards programs many companies have already in place
